(19) United States
(12) Patent Application Publication
(10) Pub. No.: US 2015/0079461 A1
(43) Pub. Date: Mar. 19, 2015

(54) MOTOR VEHICLE BATTERY HAVING AN INTERNAL TERMINAL DISCONNECT SWITCH

(71) Applicant: Lon Issac Bird, Torrington (CA)

(72) Inventor: Lon Issac Bird, Torrington (CA)

(21) Appl. No.: 14/028,770

(22) Filed: Sep. 17, 2013

(51) Int. Cl. H01M 2/30

(52) U.S. Cl. CPC H01M 2/305
USPC 429/181

(57) ABSTRACT

The present invention is directed to a motor vehicle battery having an internal terminal disconnect switch for selectively preventing current flow from a motor vehicle battery, wherein the disconnect switch comprises a housing enclosing the contact point between an external terminal of the battery and its corresponding internal terminal, wherein the housing comprises a plurality of seals for isolating the internal environment of the housing from the environment external to said housing.

### BACKGROUND OF THE INVENTION

1. Technical Field

The present invention relates to a motor vehicle battery having a disconnect switch.

2. Description of Related Art

Motor vehicle batteries are known to discharge upon storage, thereby requiring recharging or replacement following storage for an extended time. In addition, motor vehicle batteries sometimes produce an explosion when a load is connected to the battery terminal. Battery disconnect switches are a known solution to the former problem. The present invention addresses both the former problem and the latter problem.

U.S. Pat. No. 6,744,344 discloses a disconnect switch for the load circuit of a vehicle battery which includes a movable contact element and a stationary contact element that are linked with a locking mechanism. For releasing the locking mechanism a shape-memory alloy release element is used that contracts when heated. For closing the locking mechanism a shape-memory alloy spring element is provided that induces closure of the mechanism by expansion.

U.S. Pat. No. 6,492,745 discloses a battery control system for controlling the connection of a plurality of batteries to a load. The system comprises a plurality of switches and a plurality of controllers. Each switch is operable to connect or disconnect one of the batteries from the load. Each controller is operatively coupled to one of the switches. Each controller is operative to cause one of the switches to disconnect one of the batteries from the load. Each controller has an input and an output for communicating with another controller wherein the controllers communicate with each other to limit the number of batteries that can be disconnected from the loads.

U.S. Pat. No. 6,049,140 discloses a manually reversible battery disconnection system for mounting directly on a terminal of a battery of a motor vehicle. The system includes a housing; a battery terminal connector secured to the housing; a normally closed electrical switch mounted inside the housing; an electrical conductor connected to the battery terminal connector and to one side of the switch; one or more fuses mounted inside the housing, and connected between the other side of the switch and output terminals mounted on the housing; a sensor for detecting an adverse condition; an electromagnetically operated device mounted inside the housing and electrically connected to the sensor, mechanically connected to the switch, and actuable on receipt of an adverse condition signal from the sensor to open the switch; and a manual control mounted on the housing and mechanically connected to the switch for manually operating the switch.

However, the aforementioned battery disconnect switches do not provide a sealed environment for establishing or preventing the point of contact with the battery terminal.

Thus, there exists a need for a motor vehicle battery containing an internal terminal disconnect switch that provides a sealed, and therefore safe, contact point with the battery terminal. The present invention substantially fulfills this need.

### SUMMARY OF THE INVENTION

The present invention is directed to a motor vehicle battery comprising an internal terminal disconnect switch for selectively preventing current flow from said motor vehicle battery, said internal terminal disconnect switch comprising: (a) a housing enclosing the contact point between an external terminal of said battery and a corresponding internal terminal, said housing comprising a plurality of seals for isolating the internal environment of said housing from the environment external to said housing; and (b) means for moving said external terminal of said battery relative to its corresponding internal terminal within said housing, wherein contacting said external terminal to said internal terminal permits current flow from the battery, and wherein moving said external terminal away from said internal terminal to a position in which said external terminal and said internal terminal are not in contact with each other prevents current flow from the battery. In another embodiment, the present invention provides a motor vehicle battery comprising an internal terminal disconnect switch for selectively preventing current flow from said motor vehicle battery, said internal terminal disconnect switch comprising: (a) a housing enclosing the contact point between an external terminal of said battery and a corresponding internal terminal, said housing comprising a plurality of seals for isolating the internal environment of said housing from the environment external to said housing; and (b) means for moving said internal terminal of said battery relative to its corresponding external terminal within said housing, wherein contacting said internal terminal to said external terminal permits current flow from the battery, and wherein moving said internal terminal away from said external terminal to a position in which said internal terminal and said external terminal are not in contact with each other prevents current flow from the battery.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a cross-sectional view of an embodiment of the present invention.

FIG. 2 is a cross-sectional view of an embodiment of the present invention in which the internal terminal disconnect switch includes a spring which facilitates movement of the batter external terminal relative to its corresponding internal terminal.

FIG. 3 is a cross-sectional view of an embodiment of the present invention in which the internal terminal disconnect switch operates by moving the position of the internal terminal relative to the external terminal.

FIG. 4 is a cross-sectional view of an embodiment of the present invention.

In the following description of the invention similar reference characters refer to similar parts throughout the several views of the drawings.

### DETAILED DESCRIPTION

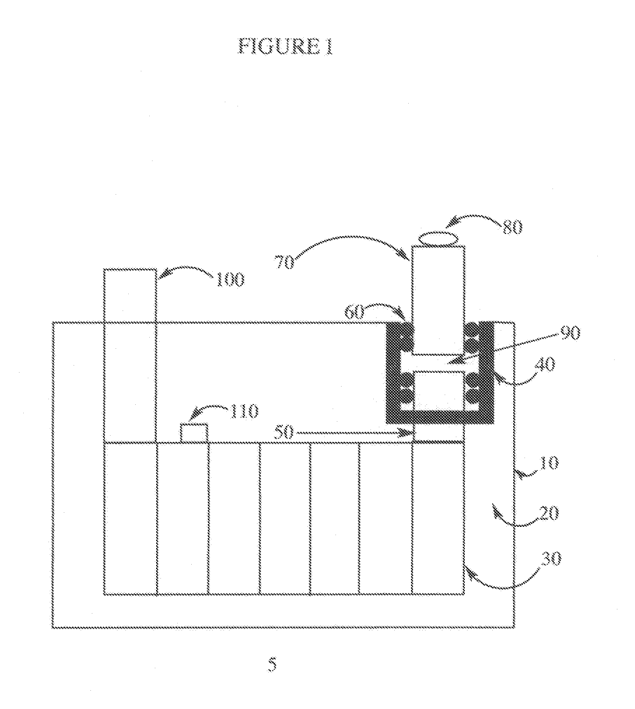

FIG. 1 show motor vehicle battery 5 having an external housing 10, electrolyte solution 20, cell plates 30, internal terminal disconnect switch housing 40, internal terminal 50, seals 60, external terminal 70, manual control 80, sealed environment 90, opposite terminal 100 and vent cap 110. In operation, manual control 80 is mechanically connected to external terminal 70 and allows a user to push external terminal 70 down so as to contact internal terminal 50, thereby allowing current to flow from motor vehicle battery 5 to an external load (not shown). Seals 60 may be affixed to housing 40, external terminal 70 and/or internal terminal 50. As shown, the point of contact between external terminal 70 and internal terminal 50 occurs in a sealed environment 90.

Alternatively, when motor vehicle battery 5 is to be stored for an extended period of time, manual control 80 allows a user to pull external terminal 70 up so as to not contact internal terminal 50, thereby preventing motor vehicle battery 5 from discharging over time. In addition, when it is desired to connect an external load to battery 5 under enhanced safety conditions, manual control 80 allows a user to pull external terminal 70 up to a position where it does not contact internal terminal 50, thereby allowing a user to connect an external load to external terminal 70 and then push external terminal 70 down to contact internal terminal 50. This sequence of events completes the electrical circuit within sealed environment 90 rather than in an open, oxygen rich environment.

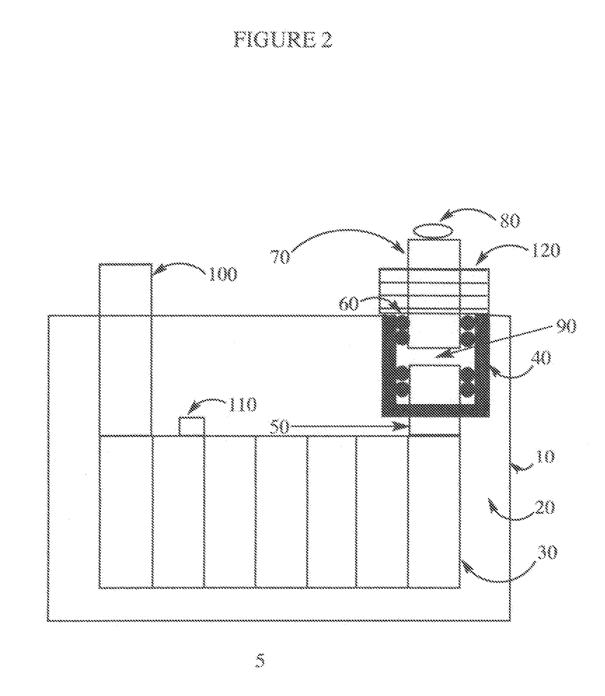

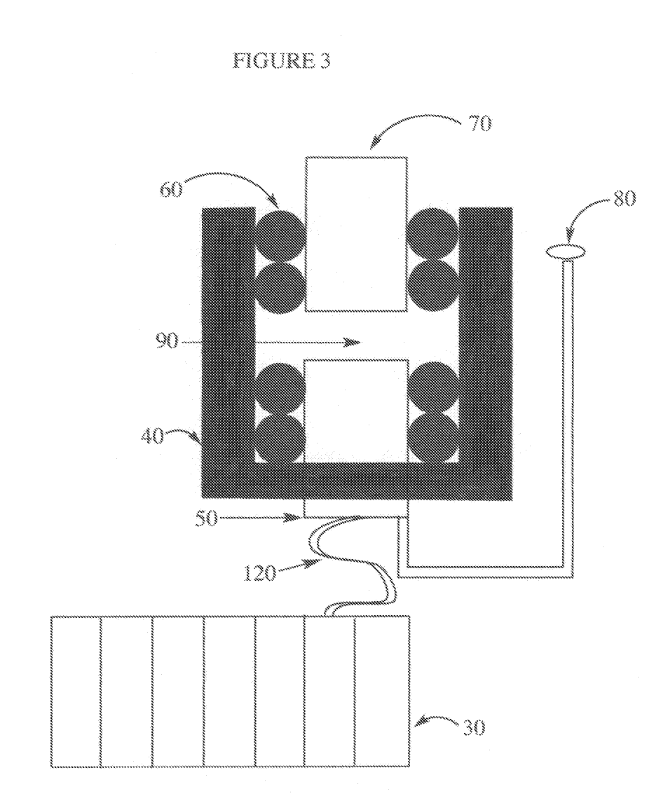

FIG. 2 show motor vehicle battery 5 having an external housing 10, electrolyte solution 20, cell plates 30, internal terminal disconnect switch housing 40, internal terminal 50, seals 60, external terminal 70, manual control 80, sealed environment 90, opposite terminal 100, vent cap 110 and spring 120. Spring 120 is affixed to housing 40. In operation, spring 120 facilitates vertical movement of external terminal 70 along a vertical axis relative to the internal terminal 50. FIG. 3 shows an alternative embodiment of the present invention, in which manual control 80 is mechanically connected to internal terminal 50 and thereby allows a user to push internal terminal 50 down to a position where it does not contact external terminal 70, thereby allowing a user to connect an external load to external terminal 70 and then pull internal terminal 50 up to contact external terminal 70. This sequence of events completes the electrical circuit within sealed environment 90 rather than in an open, oxygen rich environment.

FIG. 3 also shows electrically conductive, flexible connector 120 linking internal terminal 50 to cell plates 30. Electrically conductive, flexible connector 120 allows internal terminal 50 to move freely between an open position, where internal terminal 50 and external terminal 70 are not in contact, and a closed position, in which internal terminal 50 and external terminal 70 are in contact, while maintaining a continuous connection with cell plates 30.

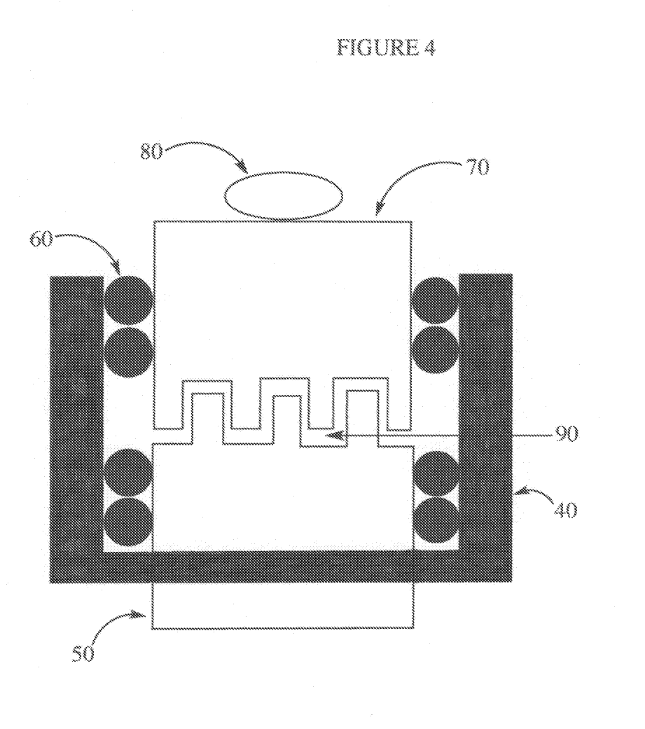

FIG. 4 shows an alternative embodiment of the present invention, in which the contact surfaces of external terminal 70 and internal terminal 50 are designed such that by using manual control 80 to rotate external terminal 70 relative to internal terminal 50 a user can easily toggle the internal terminal disconnect switch between an open position, in which external terminal 70 and internal terminal 50 are not in contact with each other, and a closed position, in which external terminal 70 and internal terminal 50 are in contact with each other. As shown, the point of contact between external terminal 70 and internal terminal 50 occurs in a sealed environment 90. Of course, although shown in FIG. 4, it is equally possible to mechanically connect manual control 80 to internal terminal 50, thereby permitting a user to toggle the internal terminal disconnect switch between an open position (shown) and a closed position (not shown) by rotating internal terminal 50 relative to external terminal 70.

While particular embodiments of the present invention have been shown and described herein for purposes of illustration, it will be understood that the invention is not limited thereto. Modifications may be made by persons skilled in the art, particularly in light of the foregoing teachings, without deviating from the spirit and scope of the invention. Accordingly, the invention is not limited except as by the appended claims.

All of the U.S. patents and published U.S. patent applications referred to in this specification are incorporated herein by reference in their entirety to the extent not inconsistent with the present description.

What is claimed is:

1. A motor vehicle battery comprising an internal terminal disconnect switch for selectively preventing current flow from said motor vehicle battery, said internal terminal disconnect switch comprising: (a) a housing enclosing the contact point between an external terminal of said battery and a corresponding internal terminal, said housing comprising a plurality of seals for isolating the internal environment of said housing from the environment external to said housing; and (b) means for moving said external terminal of said battery relative to its corresponding internal terminal within said housing, wherein contacting said external terminal to said internal terminal permits current flow from the battery, and wherein moving said external terminal away from said internal terminal to a position in which said external terminal and said internal terminal are not in contact with each other prevents current flow from the battery.

2. A motor vehicle battery according to claim 1, wherein said internal terminal disconnect switch further comprises a spring affixed to said housing, wherein said spring allows vertical movement of said external terminal relative to said internal terminal.

3. A motor vehicle battery according to claim 1, wherein said external terminal and said internal terminal are arranged such that said movement of said external terminal relative to said internal terminal is horizontal, rotational movement.

4. A motor vehicle battery according to claim 1, wherein at least one of said plurality of seals is affixed to said housing.

5. A motor vehicle battery according to claim 4, wherein at least two of said plurality of seals are affixed to said housing.

6. A motor vehicle battery according to claim 1, wherein at least one of said plurality of seals is affixed to said external terminal.

7. A motor vehicle battery according to claim 1, wherein at least one of said plurality of seals is affixed to said internal terminal.

8. A motor vehicle battery according to claim 1, wherein said means for moving said external terminal comprises a manual control mechanically connected to said external terminal.

9. A motor vehicle battery according to claim 8, wherein said manual control is removably connected to said external terminal.

10. A motor vehicle battery comprising an internal terminal disconnect switch for selectively preventing current flow from said motor vehicle battery, said internal terminal disconnect switch comprising: (a) a housing enclosing the contact point between an external terminal of said battery and a corresponding internal terminal, said housing comprising a plurality of seals for isolating the internal environment of said housing from the environment external to said housing; (b) means for moving said internal terminal of said battery relative to its corresponding external terminal within said housing, wherein contacting said internal terminal to said external terminal permits current flow from the battery, and wherein moving said internal terminal away from said external terminal to a position in which said internal terminal and said external terminal are not in contact with each other prevents current flow from the battery.

11. A motor vehicle battery according to claim 10, wherein said internal terminal disconnect switch further comprises an electrically conductive, flexible connector linking said internal terminal to a cell plate of said battery.

12. A motor vehicle battery according to claim 10, wherein said internal terminal and said external terminal are arranged such that said movement of said internal terminal relative to said external terminal is horizontal, rotational movement.

13. A motor vehicle battery according to claim 10, wherein at least one of said plurality of seals is affixed to said housing.

14. A motor vehicle battery according to claim 13, wherein at least two of said plurality of seals are affixed to said housing.

15. A motor vehicle battery according to claim 10, wherein at least one of said plurality of seals is affixed to said external terminal.

16. A motor vehicle battery according to claim 10, wherein at least one of said plurality of seals is affixed to said internal terminal.

17. A motor vehicle battery according to claim 10, wherein said means for moving said internal terminal comprises a manual control mechanically connected to said internal terminal.

18. A motor vehicle battery according to claim 17, wherein said manual control is removably connected to said internal terminal.
